(19) United States
(12) Patent Application Publication
(10) Pub. No.: US 2010/0142814 A1
(43) Pub. Date: Jun. 10, 2010

(54) IMAGE PROCESSING DEVICE FOR TONAL BALANCING OF MOSAIC IMAGES AND RELATED METHODS

(75) Inventors: Kristian Linn DAMKJER, West Melbourne, FL (US); John P. KARP, Indialantic, FL (US)

Correspondence Address: ALLEN, DYER, DOPPELT, MILBRATH & GILCHRIST, 255 S ORANGE AVENUE, SUITE 1401, ORLANDO, FL, 32801, US

(73) Assignee: Harris Corporation, Melbourne, FL (US)

(21) Appl. No.: 12/328,422

(22) Filed: Dec. 4, 2008

(51) Int. Cl. G06K 9/00

(52) U.S. Cl. 382/167

(57) ABSTRACT

An image processing device may include a memory, and a controller cooperating with the memory for registering images including overlapping portions to define a mosaic image. The controller is also for determining an exemplar, generating tonal values for the exemplar, and generating adjustment tonal values for at least some of the images based upon the tonal values for the exemplar to thereby provide tonal balancing for the mosaic image.

### GOVERNMENT LICENSE RIGHTS

The United States Government was given two (2) site-licensed copies for the Harris ORIGIN tool software in this invention. This was provided with Restricted Rights per the terms contained in the contract No. 2003-K-068250-000, which was awarded by the National Geospatial-Intelligence Agency. Harris retained the right to sell licenses for the defined software functions on future Government programs.

### FIELD OF THE INVENTION

The present invention relates to the field of image processing, and, more particularly, to processing mosaic images and related methods.

### BACKGROUND OF THE INVENTION

In certain applications, detailed imagery of large and expansive surfaces may be needed. These applications may include geographic satellite mapping, for example, where imagery of portions of the Earth's surface are gathered via satellite. A typical approach for displaying the expansive data in these applications is a mosaic image. The typical mosaic image may be formed by several smaller sized images. Before production of the mosaic image, each of the smaller images is typically registered between each other to determine their relative position. In large mosaic image applications, the registration process may be computer implemented.

Indeed, during this registration process, it is not uncommon for there to be significant overlapping portions between images. When two or more images overlap, the overlapping portions need to be resolved, i.e. one image may take precedence over the other overlapping image. An approach to resolving this conflict between overlapping image portions is image order.

Before registration of the images for a mosaic image, the images are typically subject to some form of pre-processing, which may not be automated. During the pre-processing, the images forming the mosaic image may be given an order based upon the quality of data they have, for example, geographic satellite images including substantial cloud cover would be ranked lower than satellite images including little to no cloud cover, i.e. providing a clear view of the desired geography.

Another approach to addressing the conflict in overlapping images portions is providing cut lines for each smaller image in the mosaic image. The cut lines form polygons around areas marked for retention after registration. The step for determining cut lines may be manual or computer implemented.

The above discussed process of generating a mosaic image may be subject to certain drawbacks. For example, the mosaic image may include noticeable seam lines, i.e. the boundaries between one image and a directly adjacent image. The boundaries may be noticeable for several reasons, for example, atmospheric differences between the images, tonal differences (brightness, contrast, and gamma) between the images, seasonal differences between the images, and collection differences between the images. More so, in applications without cut lines, the boundary may be readily noticeable since image borders make no allowances for features at or near the image extents.

Approaches to the balancing of the tonal differences in images of a mosaic image include, for example, seam feathering, manual adjustment of tonal properties of each image, and pair-wise adjustments. Pair-wise approaches include image-to-image histogram matching, for example. These processes are continued in a pair-wise fashion until each image in the mosaic is processed. A drawback to these methods may include noticeable propagation effects in mutually overlapping imagery in the mosaic image.

Another approach to balancing the tonal differences in mosaic images is disclosed in U.S. Pat. No. 7,317,844 to Horne. The method includes identifying in overlapping regions of the mosaic image a set of corresponding points that correspond to a single location and are indicative of a tonal variation, establishing a tonal variation threshold, and eliminating from the overlapping regions a subset of corresponding points. The subset has tonal variation deviating from the tonal variation threshold. The method also includes repeating the eliminating until substantially all subsets have been eliminated, producing adjusted overlapping regions that include a set of remaining corresponding points, obtaining gains and biases for each spectral band in the adjusted overlap regions, applying the gains and biases to transform intensities of the set of remaining corresponding points, producing transformed corresponding points, and producing a tonally balanced image mosaic using the transformed corresponding points.

Yet another approach to balancing the tonal differences in mosaic images is disclosed in U.S. Pat. No. 7,236,646 to Horne. This method includes using a subset of corresponding points in each of a plurality of image overlap regions to solve a set of minimization equations for gains and biases for each spectral band of each image. The corresponding points are points from different images having locations that correspond to each other. The subset includes corresponding points whose intensities differ less than a threshold. The method also includes applying the gains and biases to the images, and iterating the using and applying actions for a predetermined number of iterations.

### SUMMARY OF THE INVENTION

In view of the foregoing background, it is therefore an object of the present invention to provide an image processing device that efficiently provides image mosaics.

This and other objects, features, and advantages in accordance with the present invention are provided by an image processing device comprising a memory, and a controller. The controller cooperates with the memory for registering a plurality of images including overlapping portions to define a mosaic image. The controller also determines an exemplar, generates tonal values for the exemplar, and generates adjustment tonal values for at least some of the images based upon the tonal values for the exemplar to thereby provide tonal balancing for the mosaic image. Advantageously, the mosaic image has less noticeable seam lines since tonal values have been balanced.

For example, determining the exemplar may comprise at least one of: selecting a closest-to-mean image from among the images, selecting a desired image from among the images, and generating a virtual exemplar based upon the images. In some embodiments, the controller may associate the generated adjustment tonal values as metadata with the plurality of images. Also, the adjustment tonal values may comprise at least one of brightness adjustment tonal values and contrast adjustment tonal values.

Furthermore, the controller may generate adjustment tonal values based upon at least one predetermined value. The controller generates the adjustment tonal values based upon a cost function. More specifically, the images may comprise aerial images of the Earth.

Moreover, the controller may permit defining exclusion areas in the images. The adjustment tonal values may affect both brightness and contrast. The tonal values may be independent of color values.

Another aspect is directed to a computer implemented method for processing a plurality of images. The method may include registering the images including overlapping portions to define a mosaic image, determining an exemplar, generating tonal values for the exemplar, and generating adjustment tonal values for at least some of the images based upon the tonal values for the exemplar to thereby provide tonal balancing for the mosaic image.

### BRIEF DESCRIPTION OF THE DRAWINGS

FIG. 1 is a schematic diagram of an image processing device according to the present invention.

FIG. 2 is a flowchart illustrating a method for processing a plurality of images according to the present invention.

FIG. 3 is a schematic diagram illustrating a flooding operation according to the present invention.

FIG. 4 is a detailed flowchart illustrating a method for processing a plurality of images according to the present invention.

FIG. 5 is another detailed flowchart illustrating a method for processing a plurality of images according to the present invention.

FIG. 6a is a satellite image of the Earth for input into the device of FIG. 1.

FIG. 6b is the satellite image of FIG. 6a with features of mutual interest highlighted during processing by the device of FIG. 1.

FIG. 6c is the satellite image of FIG. 6a with cut lines determined using the device of FIG. 1.

FIGS. 7a-7d are detailed diagrams illustrating the flooding operation according to the present invention.

FIG. 8 is a schematic diagram of a second image processing device according to the present invention.

FIG. 9 is a flowchart illustrating a second method for processing a plurality of images according to the present invention.

FIG. 10a is a mosaic image including a plurality of satellite Earth images for input into the device of FIG. 8.

FIG. 10b is the mosaic image of FIG. 10a with tonal values balanced by the device of FIG. 8.

FIG. 11a is a mosaic image including a plurality of satellite Earth images for input into the device of FIG. 8.

FIG. 11b is the mosaic image of FIG. 11a with tonal values balanced with the device of FIG. 8.

FIG. 12 is a detailed flowchart illustrating the second method for processing a plurality of images according to the present invention.

FIG. 13 is a detailed flowchart illustrating the second method for processing a plurality of images according to the present invention.

FIG. 14 is a flowchart illustrating laying out matching points in the second method for processing a plurality of images according to the present invention.

FIG. 15 is a flowchart illustrating marking of wild points in the second method for processing a plurality of images according to the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

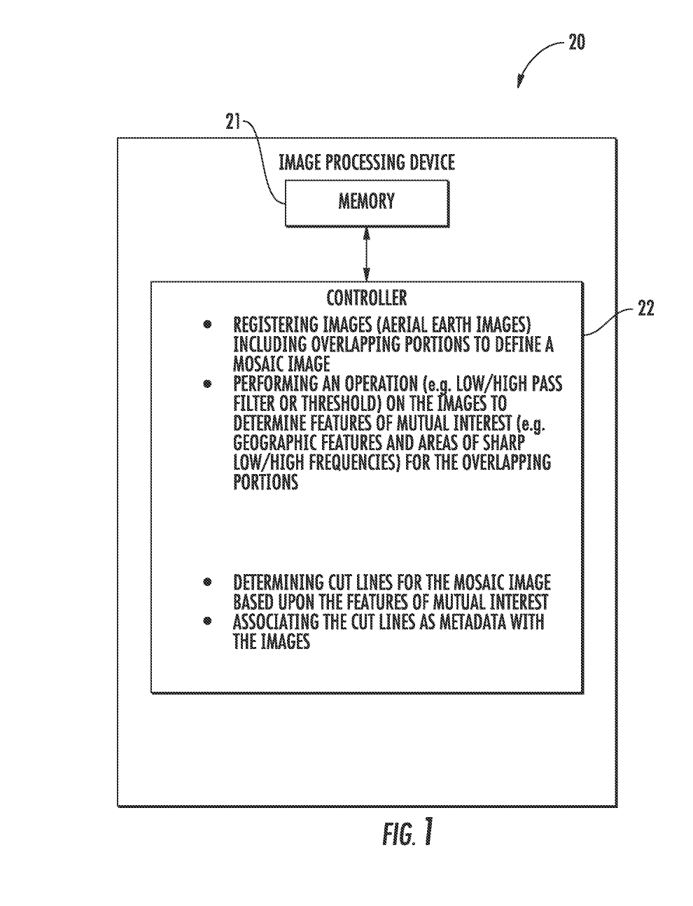

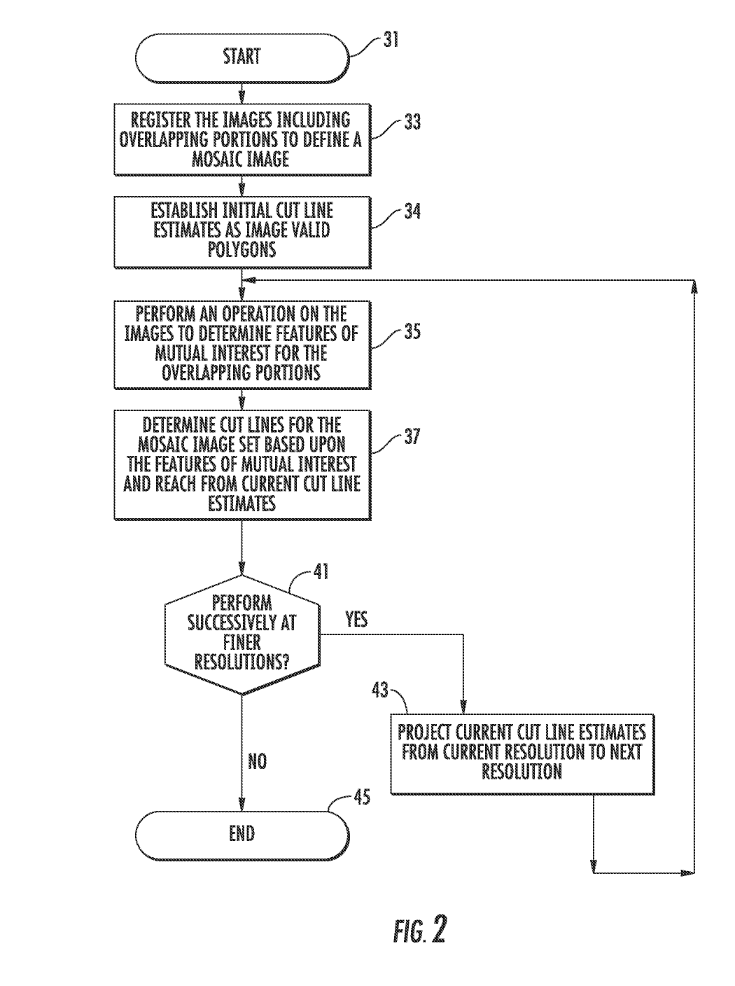

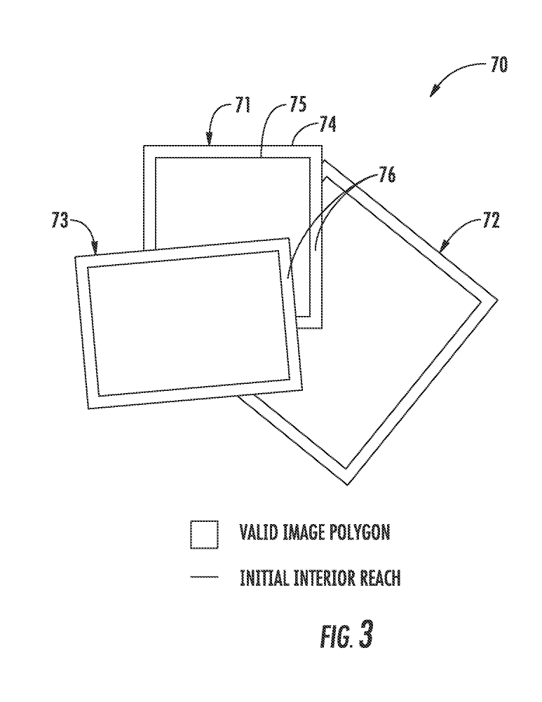

Referring initially to FIGS. 1-3, an image processing device 20 and a computer implemented method for processing a plurality of images 71-73 according to the present invention are now described with reference to a flowchart 30. The method begins at Block 31. The image processing device illustratively includes a memory 21, and a controller 22, which may include a central processing unit (CPU) of a PC, Mac, or other computing workstation, for example. Moreover, in some embodiments, the controller 22 may comprise a parallel computing architecture, i.e. at least two CPUs cooperating with each other.

The controller 22 cooperates with the memory 21 for registering the plurality of images at Block 33, for example, aerial Earth images, including overlapping portions 76 to define a mosaic image 70. As will be appreciated by those skilled in the art, the aerial Earth images may be remotely sensed and provided from a mobile aircraft platform or low/high altitude satellite, for example. Also, as will be appreciated by those skilled in the art, the image processing device 20 processes the images 71-73 to provide the mosaic image 70 to a user, i.e. piecing together the many smaller images to provide a larger cumulative image, for example, geospatially referenced images. Indeed, the images 71-73 may have varying forms of data, for example, optical, infrared, ultraviolet, or Synthetic-aperture radar (SAR). Although discussed illustratively herein in the context of aerial Earth images, the aerial Earth mosaic image is used for exemplary purposes, and the image processing device 20 may process any set of images that are to be formed into a larger mosaic image.

At Block 34, the controller 22 illustratively establishes initial cut line estimates as image valid polygons. Additionally at Block 35, the controller 22 illustratively performs at least one operation on the images 71-73 to determine features of mutual interest for the overlapping portions 76. More specifically, the operation may comprise at least one of a high pass filter operation, a low pass filter operation, a threshold filter operation, or a combination thereof, in other words, a band pass filter operation. The areas of mutual interest may include, for example, at least one of geographic feature edges and structure edges. For example, the features of mutual interest may comprise edges of areas having either high frequency data or low frequency data for each of the plurality of images. As will be appreciated by those skilled in the art, other operations may be used to determine features of mutual interest, for example, cloud/water anomaly detection operations.

At Block 37, the controller 22 also determines cut lines for the mosaic image 70 set based upon the features of mutual interest for the overlapping portions 76 and reach from current cut line estimates. At Decision Block 41, the controller 22 may iteratively perform the operation, i.e. the operation for determining features of mutual interest, on the images 71-73 to determine the cut lines more accurately. Advantageously, the cut lines are less noticeable to the user and are provided without user interaction, i.e. automatically. In short, the cut lines define masks for features in the images 71-73.

In some embodiments, the controller 22 may associate the cut lines as metadata with the images. Helpfully, the cut lines are not permanently “burned” into the images 71-73, i.e. the cut lines can be used downstream in the process since the metadata stores the cut lines rather than permanently applying the cut lines to the image data. Indeed, the cut lines are stored separately and independently in the form of polygons in the metadata. Advantageously, this method disclosed herein may be readily incorporated into existing mosaic image processing technology.

As will be appreciated by those skilled in the art, each image 71-73 in the mosaic image 70 may have a corresponding image order. Moreover, the controller 22 may determine the cut lines for the mosaic image 70 based upon corresponding order for each image 71-73.

In certain advantageous embodiments, if processing at finer more detailed resolutions is desired, the method moves to Block 43. The controller 22 may perform the operation on each image at a plurality of successively finer resolutions to determine the cut lines. More specifically, the resolutions may comprise a first resolution and a second resolution, the second resolution having greater detail than the first.

The controller 22 determines the cut lines for the mosaic image 70 based upon the first and second resolutions, each resolution associated with an interior reach 75 comprising at least one pixel, for example, sixteen pixels. The controller 22 may determine the cut line for the mosaic image 70 based upon the first and second resolutions by at least at the first resolution, performing a first flooding operation from an original edge 74 of the image at the first resolution and a cropped image based upon the interior reach, the first flooding operation defining a first cut line based upon the first resolution, and at the second resolution, performing a second flooding operation from an original edge of the image at the second resolution and a cropped image based upon the interior reach and using the first cut line as a seed. The second flooding operation may define the cut line based upon the first and second resolutions. More specifically, the controller 22 assigns an interest value on a per pixel basis. In other words, the flooding operation mimics flooding of a liquid from the interior reach 75 and the original edge 74, the pseudo elevation defining the progress of the flooding being based upon the mutual interest value of each pixel. The flooding from the interior reach 75 and the original edge 74 lines meet at the new cut line.

The method may continue until the greatest resolution level has been processed, moving to greater resolutions with each iteration. If a greater resolution level remains, the method returns back to Block 35 to determine the features of mutual interest at that resolutions. Moreover, the features of mutual interest across all resolution levels may be determined by, for example, defining features having a threshold, i.e. minimum, level of interest across each resolution level.

At Decision Block 41, once the controller 22 has determined the cut lines for each image 71-73 to a desired accuracy level or if the greatest resolution level has been processed, the method ends at Block 45.

In other embodiments, the controller 22 may perform the operation to determine the cut lines on only one resolution of the images 71-73, thereby reducing computational overhead. In other words, these embodiments provide a coarser determination of the cut lines in trade off for speed, which may be helpful given the large number of images that may be in the mosaic image 70.

The features of mutual interest in the overlapping portions 76 of the images 71-73 may vary as resolution increases. At the low resolution levels, the features of mutual interest may include large geographical features, for example, terrain features and highways. At the high resolution levels, the features of mutual interest may include smaller manmade structures, for example, edges of buildings and homes.

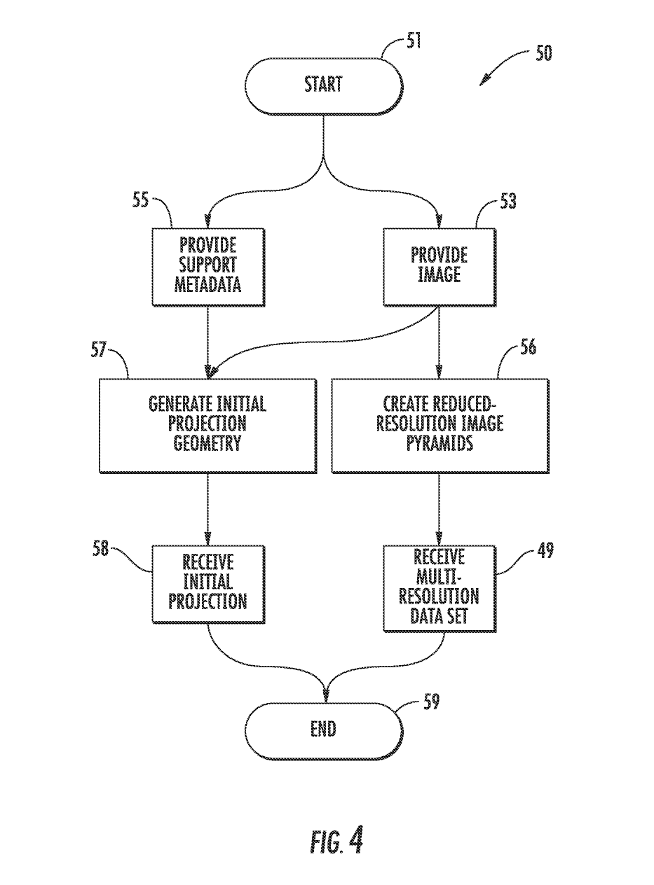

Referring now additionally to FIG. 4, as will be appreciated by those skilled in the art, a flowchart 50 illustrates an exemplary implementation for the process of preparing the images 71-73 before registration, i.e. image ingest. The flowchart begins at Block 51. At Blocks 55 and 53, the input data is provided as support metadata, i.e. information relating to how the image data was collected, and image data, i.e. the raw imagery, respectively. At Block 57, the support metadata, for example, sensor operational data, and image data are both used to generate initial projection geometry, the initial projection received at Block 58. As will be appreciated by those skilled in the art, the projection geometry provides information on how to virtually project the image raster to the ground surface. At Block 56, the image data is used to create reduced-resolution image pyramids to receive a multi-resolution data set at Block 49. The flowchart ends at Block 59.

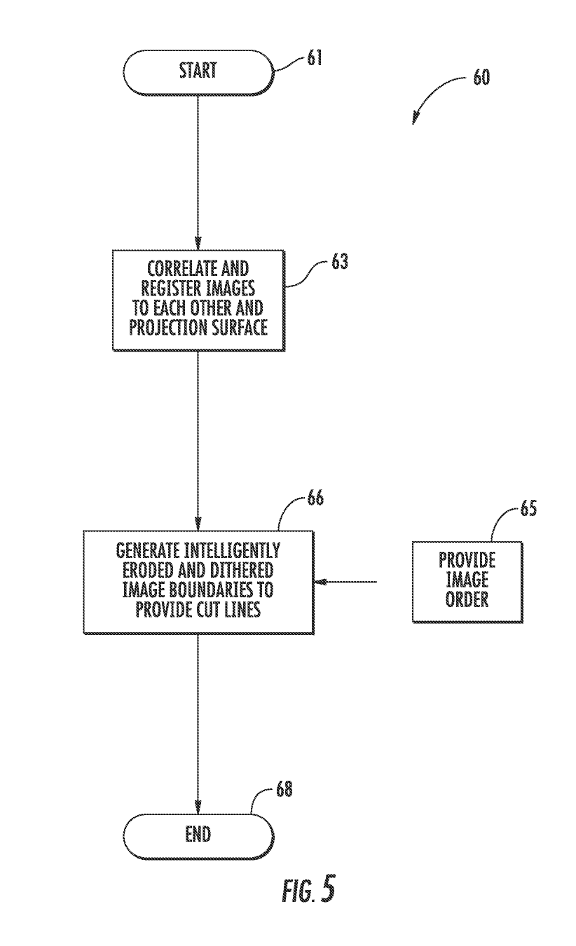

Referring now additionally to FIG. 5, as will be appreciated by those skilled in the art, a flowchart 60 illustrates an exemplary implementation of the disclosed method of processing images 71-73 and subsequent generation of the cut lines. The process begins at Block 61 and continues at Block 63, where the images 71-73 are correlated and registered together along with the projection surface to provide adjusted projections. More specifically, only the projections are modified at this point in the method and not the elevation surface. At Block 66, the process includes generating intelligently eroded and dithered image boundaries. As will be appreciated by those skilled in the art, Block 66 may include the method of processing a plurality of images 71-73 to determine cut lines based upon features of mutual interest as discussed above. At Block 65, the image order for each image is provided and may be used to generate the cut lines, which may be applied to the images 71-73 at a downstream point in the method. The process ends at Block 68.

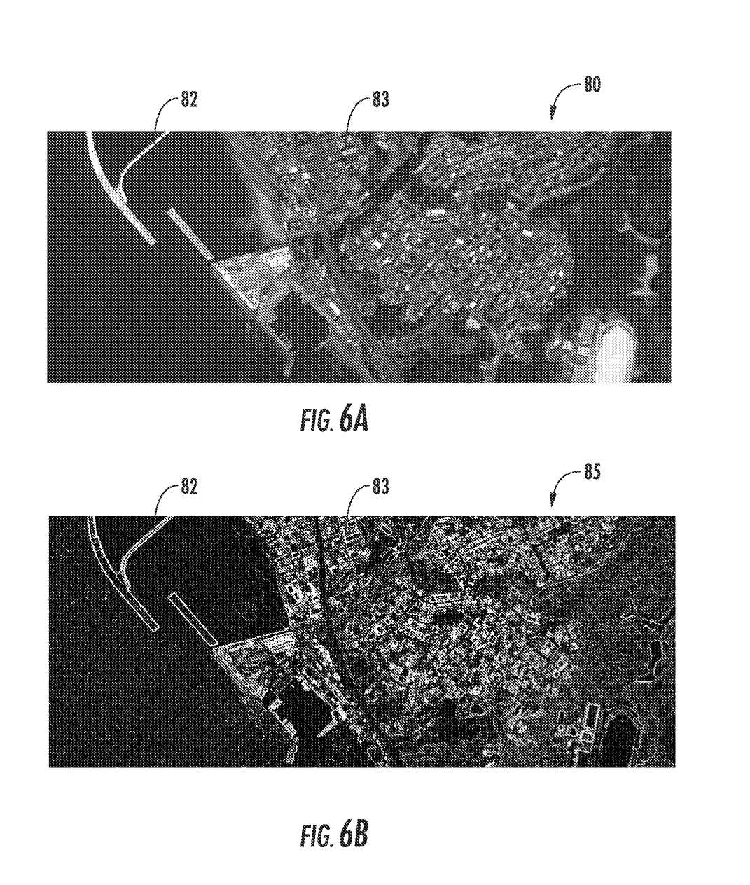

Referring to FIGS. 6a-6c, as will be appreciated by those skilled in the art, exemplary simulated results of the disclosed method are now described. An aerial image 80 of the Earth includes certain geographic features 82-83, for example, roadways, bridges, buildings etc. A salience image 85 is provided to help determine features of mutual interest, i.e. the illustrated geographic features 82-83. The salience image 85 is provided by applying the operations to the original aerial image 80, for example, low pass filter, high pass filter, or a threshold filter, in other words, a band pass filter. The method for determining cut lines discussed above is applied to produce a “cut” aerial image 81 having cut lines 84. Advantageously, the cut line 84 follows along the borders and edges of features in the aerial image 81, thereby avoiding attracting the attention from the user.

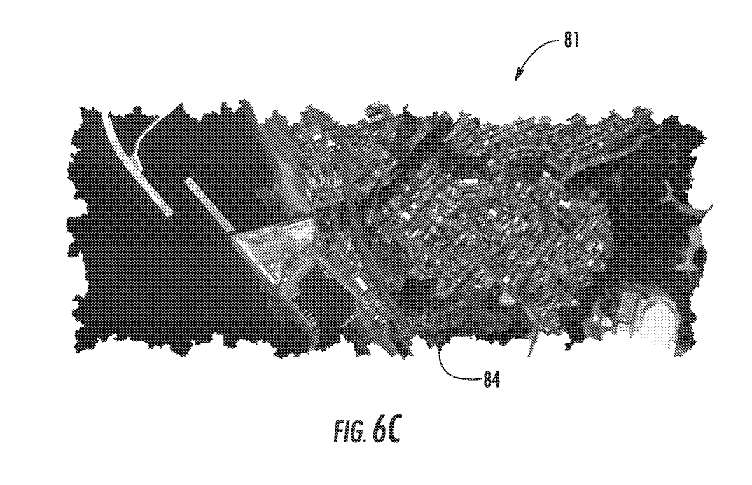

Referring now to FIGS. 7a-7d, the method for determining cut lines for an image discussed above is illustrated in four diagrams 90-93. In the first diagram 90, a first cut line 94 is determined based upon the first resolution of the image. In the second diagram 91, the image is processed at a finer second resolution, for example, the illustrated 2× zoom. The previous first cut line 94 is used as a seed to generate the refined second cut line 95. In the third diagram 92, the image is processed at a third resolution, even greater than the prior two resolutions, to determine a third refined cut line 96 based upon the prior cut lines 94-95. In the fourth diagram 93, the final cut line 96 is shown superimposed over the original imagery.

Hereinbelow, a method for balancing tonal values, for example, brightness and contrast tonal values, of the images forming a mosaic mage is disclosed. As will be appreciated by those skilled in the art, this method may be used in conjunction with the above method of determining cut lines for images before mosaic image formation, or in conjunction with other methods of forming mosaic images to reduce the appearance of seam lines due to tonal value imbalances.

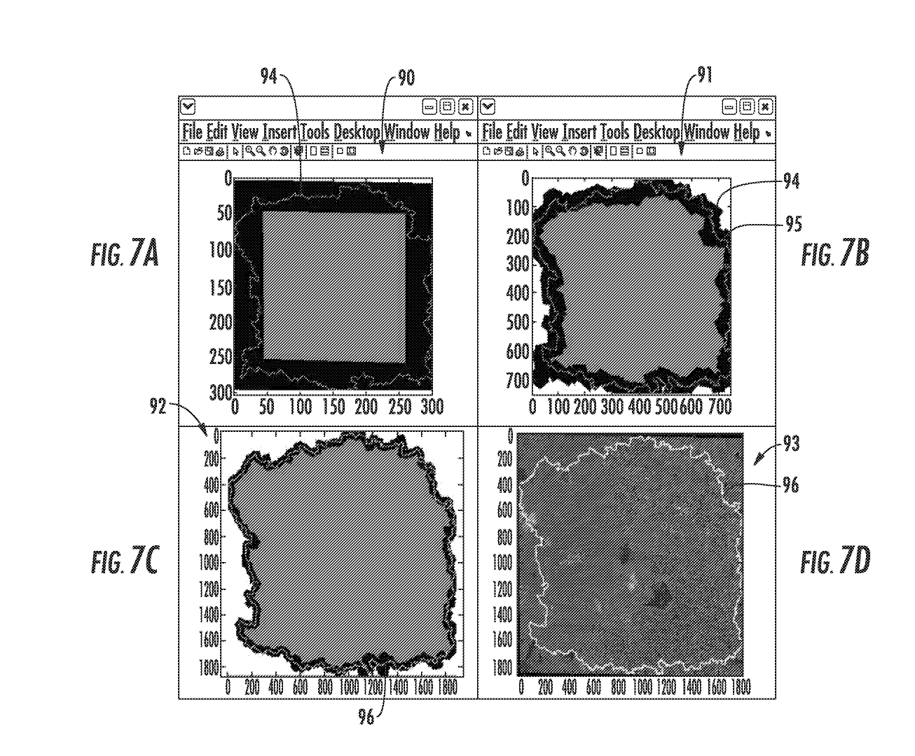

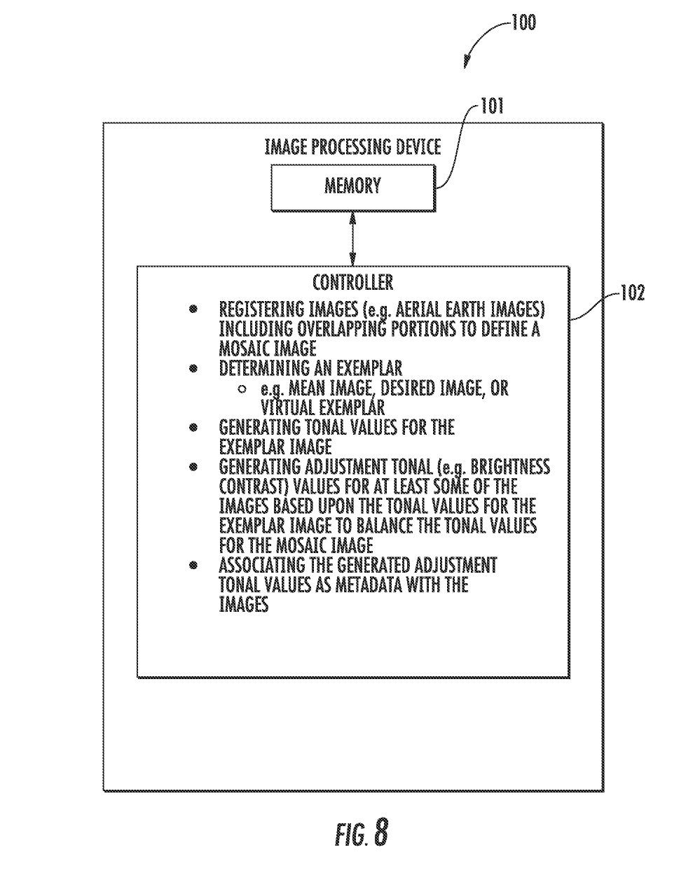

Referring now to FIGS. 8-9, an image processing device 100 and a computer implemented method for processing a plurality of images according to the present invention are now described with reference to a flowchart 110. The method begins at Block 111. The image processing device 100 illustratively includes a memory 101, and a controller 102, which may include a central processing unit (CPU) of a PC, Mac, or other computing workstation, for example. As discussed above, this controller 102 may also use a parallel computing architecture. The controller 102 cooperates with the memory 101 for registering a plurality of images including overlapping portions to define a mosaic image at Block 113.

At Block 115, the controller 102 also determines at least one exemplar. In some embodiments, the exemplar may comprise an exemplar image. For example, determining the exemplar may comprise at least one of: selecting a closest-to-mean image (representative exemplar) from among the images, selecting a desired image (intensity response representative exemplar) from among the images, and generating a virtual exemplar (statistical exemplar) based upon the images.

With the closest-to-mean exemplar image, the controller 102 automatically locks, i.e. the tonal values for this image are static/invariant during balancing, onto a contributing image in the mosaic image. This locked image represents the least deviation across all bands relative to the set average mean and average mean absolute deviations per band.

With the desired exemplar, the controller 102 automatically locks onto the contributing image in the mosaic image that demonstrates the most ideal response signature across all bands. In other words, the desired exemplar is the image that looks the best to the user for features contained within the images, for example, clouded over images and water body images. As will be appreciated by those skilled in the art, the desired exemplar may alternatively be based upon user preferences for the intended application of the mosaic image, i.e. the exemplar may comprise a set of user desired tonal values. For example, the desired exemplar may have tonal values for highly saturated tones.

With the virtual exemplar, none of the contributing images in the mosaic image are locked. Rather, a statistical representation of the desired set of tonal values is generated. In other words, all of the images of the mosaic image have their tonal values adjusted. At Block 117, the controller 102 generates tonal values for the exemplar. In other words, the controller 102 derives what are the desired tonal values, for example, a brightness value, a contrast value, and a gamma value.

At Block 121, the controller 102 generates adjustment tonal values for at least some of the images based upon the tonal values for the exemplar to thereby provide tonal balancing for the mosaic image. For example, the adjustment tonal values may affect perceived contrast and brightness independently of color values, for example, red, green, and blue hue values. Advantageously, the mosaic image has less noticeable seam lines since tonal values have been balanced. In some embodiments, the controller 102 may associate the generated adjustment tonal values as metadata with the plurality of images. The method ends at Block 123.

In some embodiments, the controller 102 may generate adjustment tonal values based upon at least one predetermined value. In other embodiments, the controller 102 may generate the adjustment tonal values based upon a cost function. More specifically, based upon a cost minimization function, the adjusted tonal values may approach the desired tonal values but likely will not actually reach the desired tonal values. Moreover, the controller 102 may generate adjustment tonal values in an iteratively manner. In other words, once the exemplar has been determined and the adjustment tonal values have been applied, a second exemplar may be selected and the process may be repeated.

In some embodiments, the controller 102 may associate the generated adjustment tonal values as metadata with the plurality of images. Advantageously, this method disclosed herein may be readily incorporated into existing mosaic image processing technology deployed downstream.

Advantageously, the controller 102 may permit defining exclusion areas in the images. Thereby, areas of known or discoverable anomalies, for example, water bodies and clouds, may be excluded to improve the generated adjustment tonal values.

As discussed above, there are at least three methods for determining an exemplar for the mosaic image, each method having desirable traits. For example, the closest-to-mean image exemplar (representative exemplar) may tend to adjust the images the least while maintaining band relativity and may be less sensitive to outlier influences. With the desired exemplar (intensity response representative exemplar) method, the method may adjust images from the mosaic image significantly from their original state, but still maintains band-relativity while adjusting the overall set to a desired response. With the virtual exemplar (statistical exemplar), this method is the most fluid approach since all the images are permitted to adjust. Although providing a balanced approach, depending on the statistical representation, this method may cause the mosaic image to become de-saturated. Moreover, since none of the images are locked, band relativity may be lost unless mitigated in some way, for example, by adjusting in luminance-chrominance space.

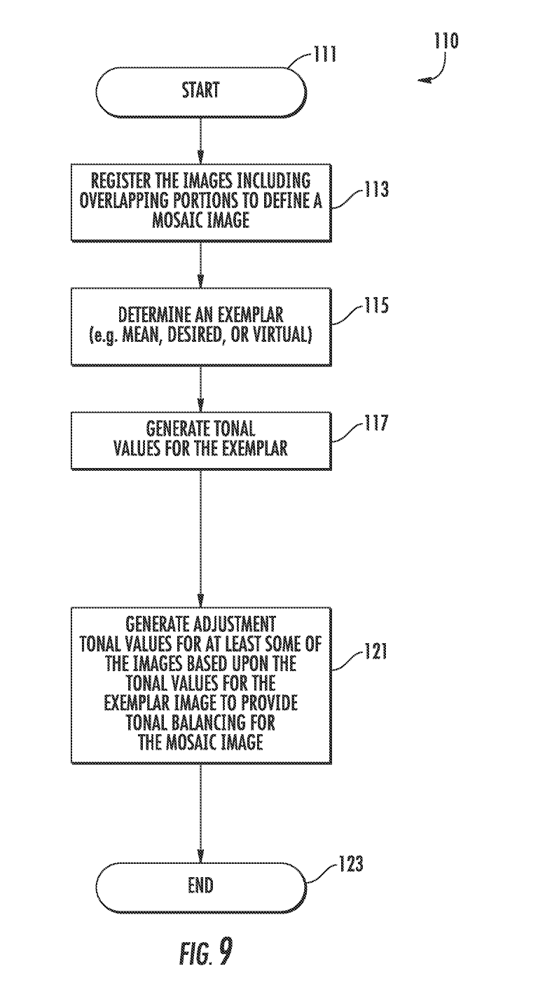

Referring now additionally to FIGS. 10a-10b, as will be appreciated by those skilled in the art, exemplary simulated results of the disclosed method are now described. An unbalanced mosaic image 140 includes a plurality of images 141a-141g images having varying tonal values. Since the images are unbalanced, the mosaic image 140 has noticeable seam lines 144. The method for balancing tonal values is applied to generate a balanced mosaic image 142 where the linear seam lines are less noticeable.

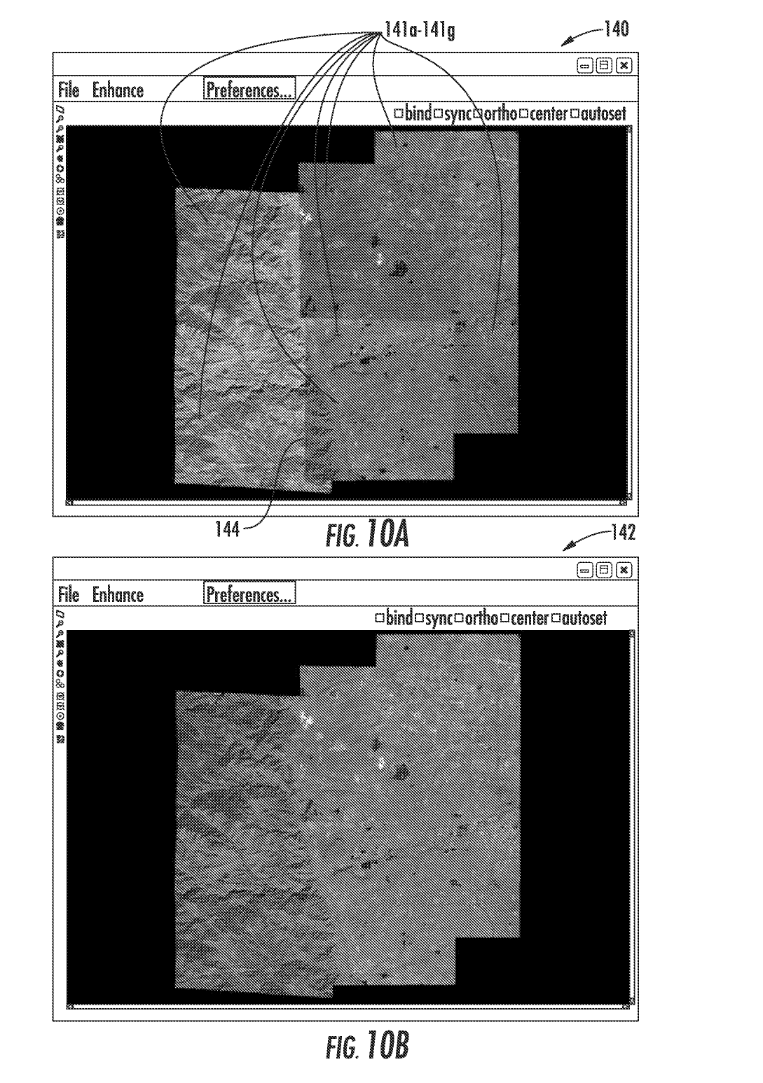

Referring now additionally to FIGS. 11a-11b, an unbalanced mosaic image 145 includes a plurality of images 146a-146b images having varying tonal values. Since the images 146a-146b are unbalanced, the mosaic image 145 has noticeable seam lines 149. The method for tonal values is applied to generate a balanced mosaic image 147 where the linear seam lines are less noticeable.

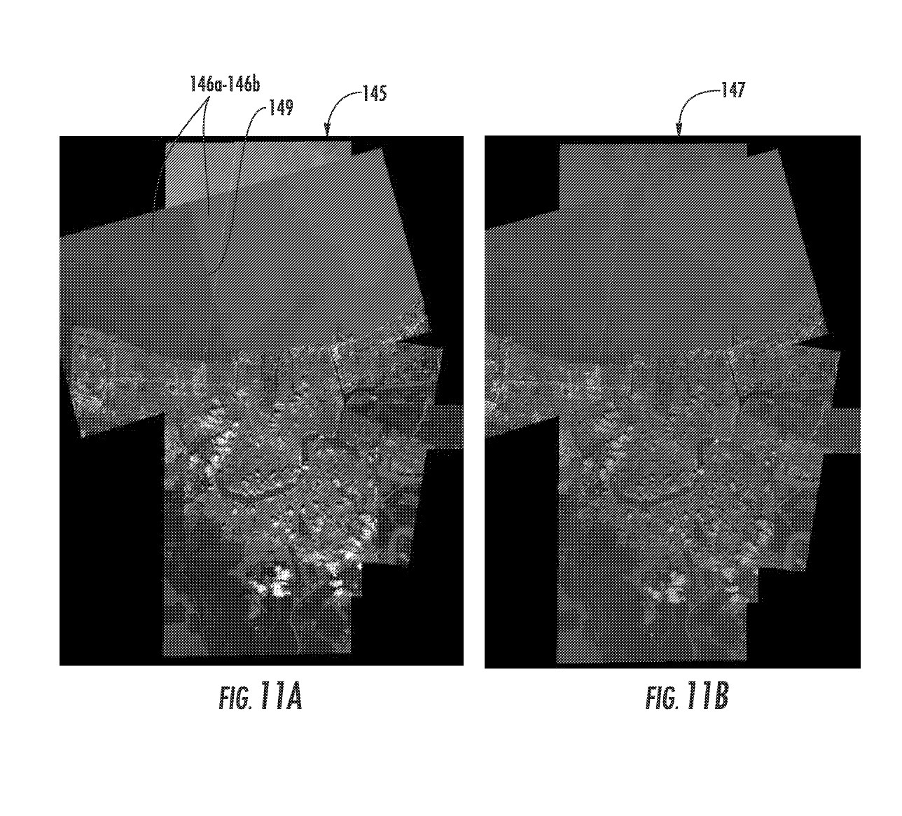

Referring now additionally to FIG. 12, as will be appreciated by those skilled in the art, a flowchart 130 illustrates an exemplary process of registering the images and subsequent balancing of tonal values. The process begins at Block 131 and continues at Block 133 where the images are correlated and registered together along with the projection surface to provide adjusted projections. At Block 135, the process includes balancing tonal values for each image in the mosaic image. As will be appreciated by those skilled in the art, Block 135 may include the method for balancing tonal values described above. The adjustment tonal values are applied on an image-by-image basis at some subsequent point downstream. The process ends at Block 137.

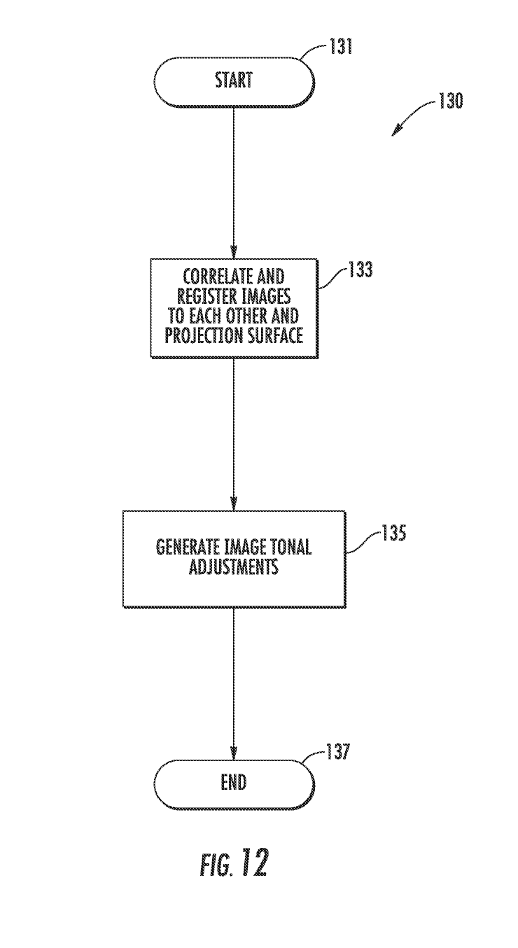

Referring now to FIG. 13 and a flowchart 150 shown therein, an exemplary implementation of the method of balancing tonal values in a mosaic image is described. The method begins at Block 151. At Block 153, the method illustratively includes determining potential overlap between adjacent images in the mosaic image. At Block 154, the method illustratively includes adding exclusion areas, for example, clouds and water bodies representing pre-determined or independently discoverable areas known to represent tonal anomalies that may throw off the balancing method.

The method illustratively includes laying out match points at Block 155, and computing statistics at Block 156. At Block 157, the wild points are removed to improve the reliability of the balancing. For example, points outside a statistical threshold may be removed. At Block 158, the exemplar is either selected or computed if not explicitly provided, and a minimization cost function is applied at Block 159. The method ends at Block 160.

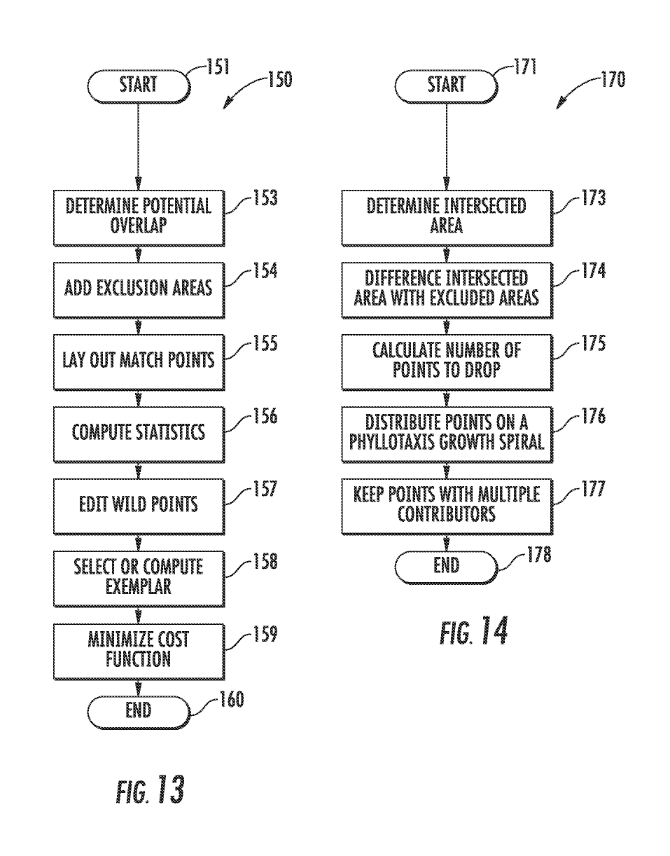

Referring now to FIG. 14 and a flowchart 170 shown therein, an exemplary implementation for laying out the matching points is now described. The process begins at Block 171 and illustratively includes determining the intersecting area at Block 173. At Block 174, the process illustratively includes differencing the intersected area with the excluded areas. The method illustratively includes calculating a number of points to drop at Block 175, and distributing points on a phyllotaxis growth spiral at Block 176. At Block 177, the method illustratively includes keeping the points with multiple contributors. The method ends at Block 178.

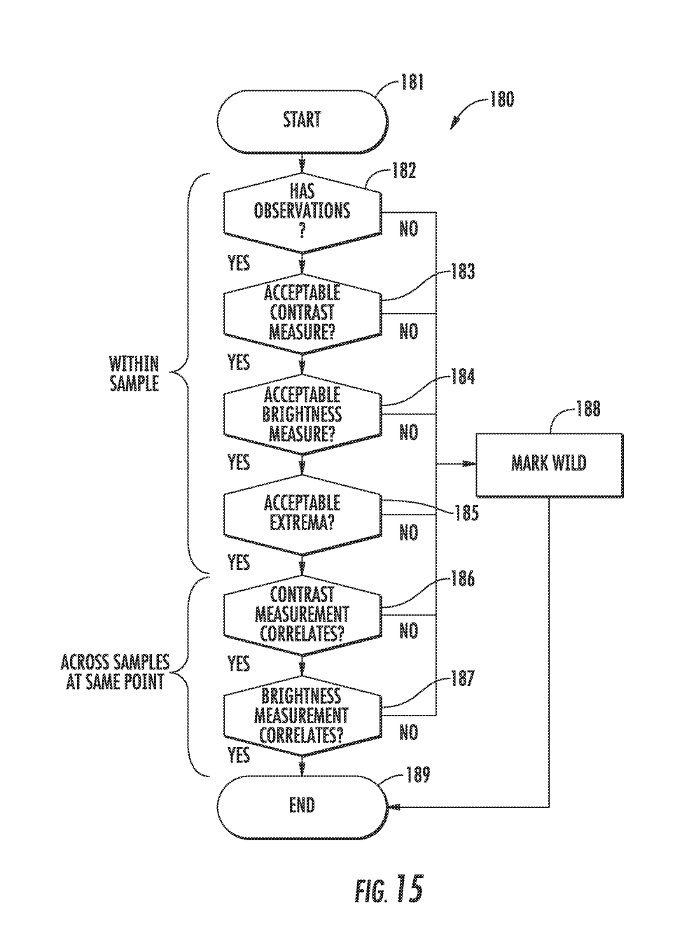

Referring now to FIG. 15 and a flowchart 180 shown therein, an exemplary implementation for editing out the wild points is now described. The process begins at Block 181 and illustratively includes determining whether: there are observations at Decision Block 182; there are acceptable contrast measures at Decision Block 183; there are acceptable brightness measures at Decision Block 184; there are acceptable extrema at Decision Block 185; the contrast measures correlate at Decision Block 186; and the brightness measures correlate at Decision Block 187. If the answer to any one of the Decision Blocks 182-187 is no, the process moves to Block 188 and the point is marked wild before the method ends at Block 189. If the answer to all of the Decision Blocks 182-187 is yes, the point is not marked wild and the method ends at Block 189.

Other features relating to processing mosaic images are disclosed in co-pending application “IMAGE PROCESSING DEVICE FOR DETERMINING CUT LINES AND RELATED METHODS”, Attorney Docket No. 61683, incorporated herein by reference in its entirety.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. An image processing device comprising:
a memory; and
a controller cooperating with said memory for registering a plurality of images including overlapping portions to define a mosaic image;
said controller also for
determining an exemplar,
generating tonal values for the exemplar, and
generating adjustment tonal values for at least some of the plurality of images based upon the tonal values for the exemplar to thereby provide tonal balancing for the mosaic image.

2. The image processing device according to claim 1 wherein determining the exemplar comprises selecting a closest-to-mean image from among the plurality of images.

3. The image processing device according to claim 1 wherein determining the exemplar comprises selecting a desired image from among the plurality of images.

4. The image processing device according to claim 1 wherein determining the exemplar comprises generating a virtual exemplar based upon the plurality of images.

5. The image processing device according to claim 1 wherein said controller associates the generated adjustment tonal values as metadata with the plurality of images.

6. The image processing device according to claim 1 wherein the adjustment tonal values comprise at least one of brightness adjustment tonal values and contrast adjustment tonal values.

7. The image processing device according to claim 1 wherein said controller generates adjustment tonal values based upon at least one predetermined value.

8. The image processing device according to claim 1 wherein said controller generates the adjustment tonal values based upon a cost function.

9. The image processing device according to claim 1 wherein the plurality of images comprises aerial images of the Earth.

10. The image processing device according to claim 1 wherein said controller permits defining exclusion areas in the plurality of images.

11. The image processing device according to claim 1 wherein the adjustment tonal values affect both brightness and contrast.

12. The image processing device according to claim 1 wherein the tonal values are independent of color values.

13. An image processing device comprising:
a memory; and
a controller cooperating with said memory for registering a plurality of images including overlapping portions to define a mosaic image;
said controller also for
determining an exemplar,
generating tonal values for the exemplar, the tonal values affecting both brightness and contrast,
generating adjustment tonal values for at least some of the plurality of images based upon the tonal values for the exemplar to thereby provide tonal balancing for the mosaic image, and
associating the generated adjustment tonal values as metadata with the plurality of images.

14. The image processing device according to claim 13 wherein determining the exemplar comprises selecting a closest-to-mean image from among the plurality of images.

15. The image processing device according to claim 13 wherein determining the exemplar comprises selecting a desired image from among the plurality of images.

16. The image processing device according to claim 13 wherein determining the exemplar comprises generating a virtual exemplar based upon the plurality of images.

17. The image processing device according to claim 13 wherein the adjustment tonal values comprise at least one of brightness adjustment tonal values and contrast adjustment tonal values.

18. A computer implemented method for processing a plurality of images comprising:
registering the plurality of images including overlapping portions to define a mosaic image;
determining an exemplar;
generating tonal values for the exemplar; and
generating adjustment tonal values for at least some of the plurality of images based upon the tonal values for the exemplar to thereby provide tonal balancing for the mosaic image.

19. The computer implemented method according to claim 18 wherein determining the exemplar comprises selecting a closest-to-mean image from among the plurality of images.

20. The computer implemented method according to claim 18 wherein determining the exemplar comprises selecting a desired image from among the plurality of images.

21. The computer implemented method according to claim 18 wherein determining the exemplar comprises generating a virtual exemplar based upon the plurality of images.

22. The computer implemented method according to claim 18 further comprising associating the generated adjustment tonal values as metadata with the plurality of images.
